(19) United States
(12) Patent Application Publication
(10) Pub. No.: US 2026/0034647 A1
(43) Pub. Date: Feb. 5, 2026

(54) WORK MACHINE

(71) Applicant: Koki Holdings Co., Ltd., Tokyo (JP)

(72) Inventors: Ryosuke NAKANO, Ibaraki (JP); Goya FUJIMOTO, Ibaraki (JP); Yutaka WATANABE, Ibaraki (JP)

(73) Assignee: Koki Holdings Co., Ltd., Tokyo (JP)

(21) Appl. No.: 18/998,317

(22) PCT Filed: Jul. 21, 2023
(86) PCT No.: PCT/JP2023/026860

§ 371 Date: Jan. 24, 2025

(30) Foreign Application Priority Data
Jul. 29, 2022 (JP) 2022-121418

(51) Int. Cl. B25B 23/14; B25F 5/00

(52) U.S. Cl. CPC B25B 23/141; B25F 5/001

(57) ABSTRACT

The present invention provides a downsizing while accommodating variations. In a driver drill, a switching ring of a switching mechanism for switching a striking-force-application mechanism of the driver drill to an inoperative or operative state is removably mounted to a nut of a clutch mechanism. In other words, the nut has a mounting portion for mounting the switching ring for switching an operation mode of a spindle. This allows the driver drill to accommodate variations while contributing to the downsizing of a body size.

### BACKGROUND OF THE INVENTION

### Field of Invention

The present invention relates to a work machine.

### Description of Related Art

In a driver drill (work machine) described in Patent Literature 1 below, a driving force of a motor is transmitted to a spindle by a transmission mechanism consisting of a planetary gear mechanism, and the spindle rotates. This allows, for example, tightening work and so on to be performed. The driver drill also has a clutch mechanism, and when a transmission torque transmitted to the spindle reaches an upper limit value, the clutch mechanism shuts off a transmission of the driving force to the spindle. Furthermore, in the clutch mechanism, a nut can be moved back and forth by rotating a clutch ring to change the upper limit value of the transmission torque.

### RELATED ART LITERATURE

### Patent Literature

### [Patent Literature 1]

Japanese Unexamined Patent Application Publication No. 2011-245609.

### SUMMARY OF THE INVENTION

### Disclosure of Invention

### [Problem to be Solved by Invention]

Some driver drills have two modes: a rotation mode in which a rotational force is applied to the spindle, and a rotary striking mode in which rotational and striking forces are applied to the spindle. In the driver drill with the rotary striking mode, a striking-force-application mechanism for applying striking force to the spindle and a switching mechanism for switching the mode from the rotation mode to the rotary striking mode are added, and the switching mechanism is interlocked with a movement of the nut.

Here, in the driver drill with the rotary striking mode, the switching mechanism is activated by the nut. In order to activate the switching mechanism, this nut is larger in size than the nut of the driver drill without the rotary striking mode. Therefore, if the nut of the driver drill with the rotary striking mode is adopted for the above two types of the driver drills for a purpose of sharing parts, the driver drill without the rotary striking mode becomes larger in size. In other words, it is desirable for the driver drill to have a structure that can contribute to downsizing while accommodating various variations.

Considering the above facts, the present invention aims to provide the work machine that can accommodate variations while contributing to downsizing.

### [Means to Solve Problem]

At least one embodiment of the present invention is a work machine comprising: a motor; a transmission mechanism that transmits a driving force of the motor to a spindle to rotate the spindle; a clutch mechanism that shuts off power transmission from the motor to the spindle when a transmission torque to the spindle by the transmission mechanism reaches an upper limit value; and a torque setting portion that configures a portion of the clutch mechanism and is activated by an operator to set the upper limit value; wherein the torque setting portion has a mounting portion for mounting a switching member that switches an operation mode of the spindle.

At least one embodiment of the present invention is the work machine comprising: a striking-force-application mechanism provided on radially outside of the spindle to apply a striking force in the axial direction of the spindle; and a switching mechanism that switches the striking-force-application mechanism to an operative or inoperative state; wherein the switching member configures the portion of the switching mechanism.

At least one embodiment of the present invention is the work machine, wherein the torque setting portion is disposed on one side in the axial direction with respect to the transmission mechanism and is movable in the axial direction, wherein the mounting portion is provided at one end of the torque setting portion in the axial direction, and the switching mechanism is disposed radially inside of the spindle with respect to the torque setting portion.

At least one embodiment of the present invention is the work machine, wherein the torque setting portion and the switching member are formed in a cylindrical shape disposed radially outside of the spindle, wherein the switching member has a mounted portion that is mounted to the mounting portion, wherein the mounted portion is mounted to the mounting portion in a circumferential engagement with the torque setting portion and is moored to the mounting portion by a mooring member.

At least one embodiment of the present invention is the work machine, wherein the mooring member is a C-ring mounted to the mounting portion and the mounted portion.

### [Advantage of Present Invention]

According to one or more embodiments of the invention, it is possible to accommodate variations while contributing to downsizing.

### BRIEF DESCRIPTION OF THE DRAWINGS

FIG. 1 is a longitudinal cross-sectional view of a driver drill according to the present embodiment.

FIG. 2 is an enlarged longitudinal cross-sectional view of a driving-force-transmission mechanism, a striking-force-application mechanism, and a switching mechanism illustrated in FIG. 1.

FIG. 3 is an exploded view of a clutch mechanism and a switching ring illustrated in FIG. 2, viewed from left oblique rear.

FIG. 4 is the exploded view of the clutch mechanism and the switching ring illustrated in FIG. 3, viewed from left oblique forward.

FIG. 5 is an exploded oblique view of the striking-force-application mechanism and the switching mechanism illustrated in FIG. 2, viewed from left oblique rear.

FIG. 6 is the exploded oblique view of the striking-force-application mechanism and the switching mechanism illustrated in FIG. 5, viewed from left oblique forward.

FIG. 7 is the longitudinal cross-sectional view corresponding to FIG. 2 illustrating a variation of the driver drill.

### DETAILED DESCRIPTION OF THE INVENTION

The following description of a driver drill 1 as a work machine will be described using drawings. Arrows UP, FR, and RH illustrated in the drawings as appropriate indicate upper, front, and right sides of the driver drill 1, respectively. In the following description, when directions up-down, front-back, and left-right are used, they will indicate vertical, front and back, and left and right directions of the driver drill 1, unless otherwise noted.

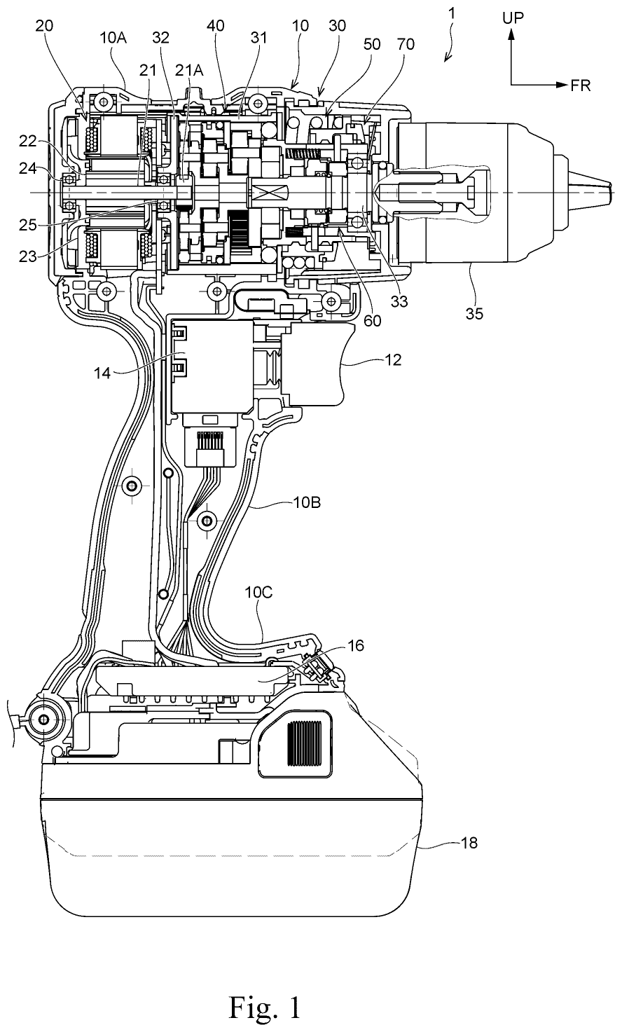

As illustrated in FIG. 1, the driver drill 1 is configured as a power tool that performs tightening and other operations by mounting a tip tool to a chuck 35 provided on a front end of the driver drill 1 and applying a rotational force to the tip tool. The driver drill 1 has two modes: a rotation mode in which the rotational force is applied to the tip tool, and a rotary striking mode in which the rotational force and an striking force are applied to the tip tool, and is configured to be switchable to the rotation mode or the rotary striking mode.

The driver drill 1 comprises: a housing 10 that constitutes an outline of the driver drill 1; a motor 20 housed in the housing 10; a driving-force-transmission mechanism 30 that transmits the driving force of the motor 20 to a spindle 33; a striking-force-application mechanism 60 for applying the striking force to the tip tool; and a switching mechanism 70 that switches the striking-force-application mechanism 60 to an inoperative or operative state. The following are descriptions of each configuration of the driver drill 1.

### Housing 10

The housing 10 is formed in a hollow, substantially I-shape viewed from right. Specifically, the housing 10 comprises: an upper housing 10A configuring an upper end of the housing 10 and extending in front-back direction; a handle 10B extending downward from a middle in the front-back direction of the upper housing 10A; and a lower housing 10C configuring a lower end of the housing 10. The housing 10 is configured with a plurality of housing members, which are assembled together to form the housing 10.

A trigger 12 is provided at the upper end of the handle 10B. The trigger 12 protrudes from the handle 10B to front and can be pulled to rear. The handle 10B is provided with a switch mechanism 14 at the rear of the trigger 12. The switch mechanism 14 has a switch, not illustrated, which switches from OFF to ON when the trigger 12 is pulled.

A controller 16 is provided at the lower housing 10C. The switch of the switch mechanism 14 is electrically connected to the controller 16, and an output signal corresponding to the operative state of the trigger 12 is output from the switch to the controller 16. A battery 18 is removably attached in the lower housing 10C. The battery 18 is electrically connected to the controller 16, and an electric power is supplied to the motor 20 by the battery 18.

### Motor 20

The motor 20 is housed in a rear end of the upper housing 10A and is electrically connected to the controller 16. The motor 20 comprises a drive shaft 21 with the front-back direction as axial direction), a rotor 22 integrally rotatably coupled to the drive shaft 21, and a substantially cylindrical shaped stator 23 disposed radially outward of the rotor 22.

The rear end of the drive shaft 21 is rotatably supported by a rear side motor bearing 24 fixed to the housing 10. A front end portion of the drive shaft 21 is rotatably supported by a front side motor bearing 25 fixed to a motor spacer 32. The motor spacer 32 is formed in a substantially disc shape with the front-back direction as thickness direction, and is mounted to the rear end of a gear case 31, described further below. The front end of the drive shaft 21 protrudes toward the front of the motor spacer 32 and is disposed in the gear case 31. The front end of the drive shaft 21 is provided with a pinion gear 21A.

### Driving-Force-Transmission Mechanism 30

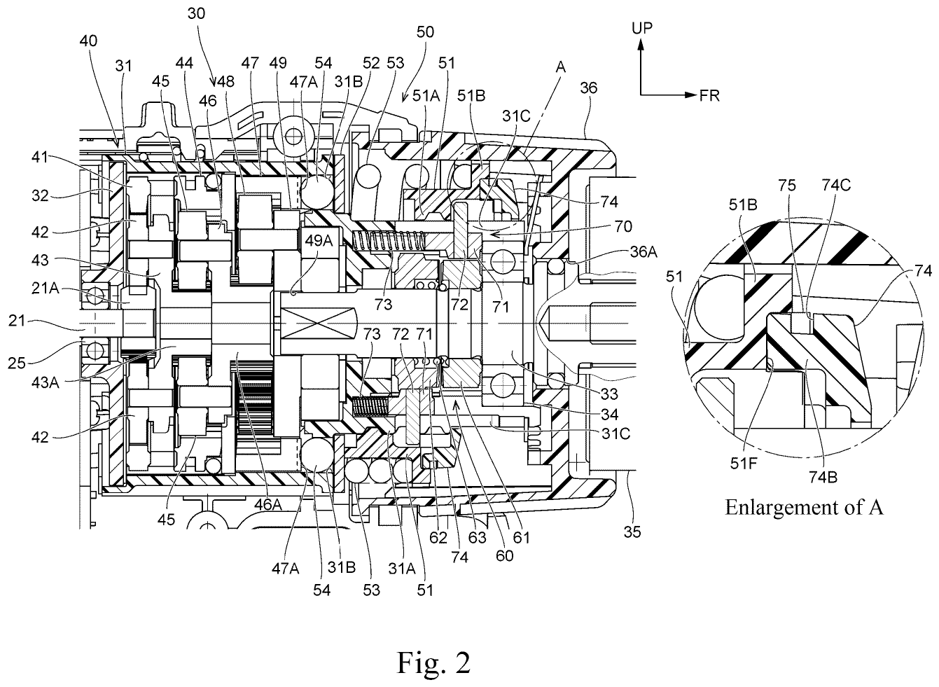

As illustrated in FIG. 1 and FIG. 2, the driving-force-transmission mechanism 30 comprises: the gear case 31 that constitutes the outline of the driving-force-transmission mechanism 30; a reduction mechanism 40 as a transmission mechanism that transmits the driving force of the motor 20 to the spindle 33; and a clutch mechanism 50 that shuts off drive transmission to the spindle 33 when a transmission torque to the spindle 33 reaches an upper limit value.

### Gear Case 31

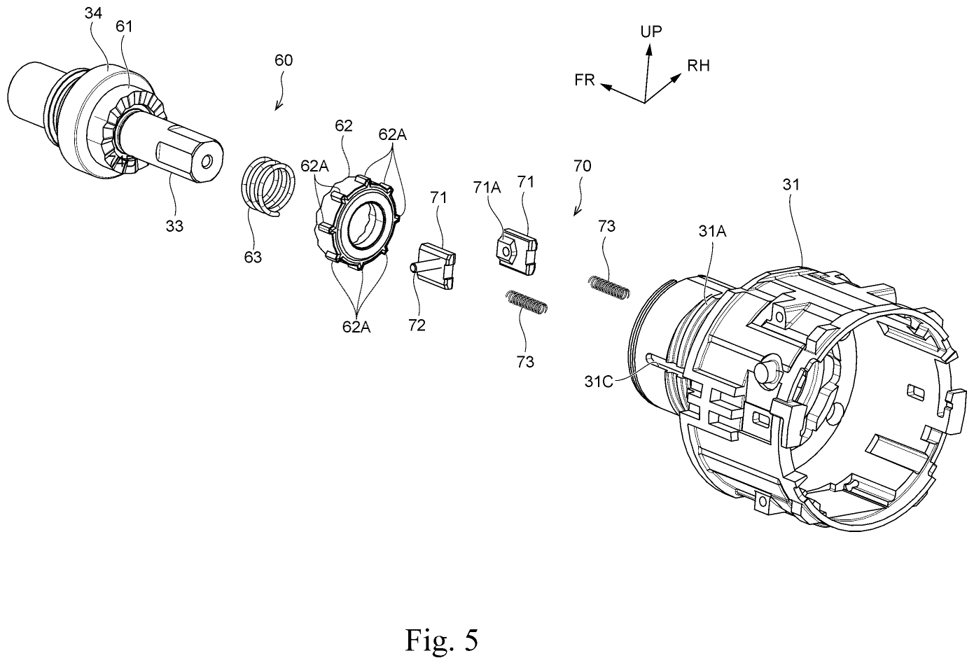

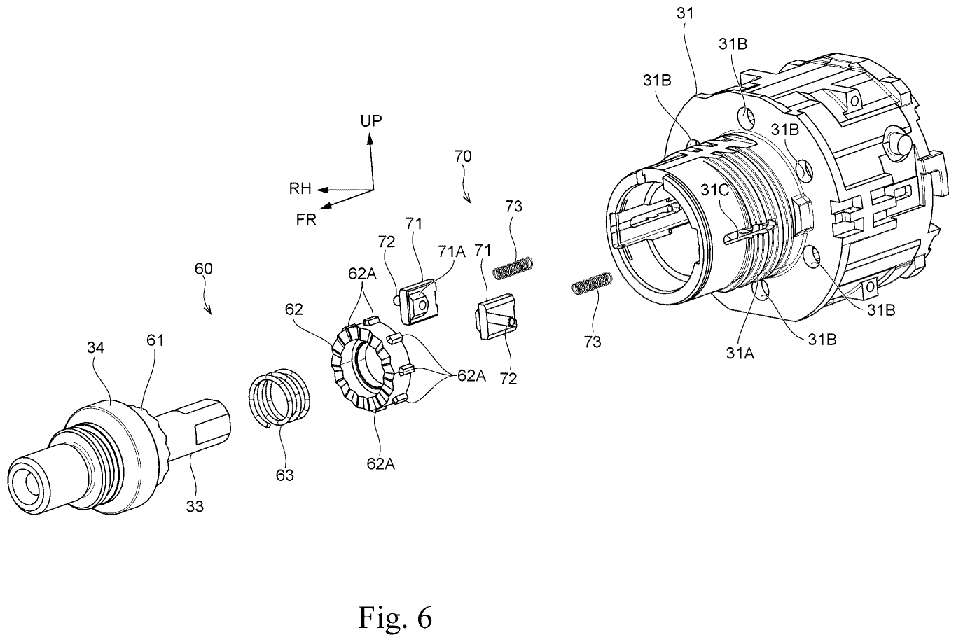

As also illustrated in FIG. 5 and FIG. 6, the gear case 31 is formed in a substantially stepped cylindrical shape with the front-back direction as the axial direction, and a diameter of a front portion of the gear case 31 is smaller than that of a rear portion of the gear case 31. The gear case 31 is housed within the front portion of the upper housing 10A. The above-mentioned motor spacer 32 is fitted into the rear end of the gear case 31, and the rear end of the gear case 31 is closed by the motor spacer 32. The front portion of the gear case 31 is provided with the spindle 33 with the front-back direction as the axial direction, and the spindle 33 is disposed coaxially aligned with the drive shaft 21 of the motor 20. The front end portion of the spindle 33 is rotatably supported by a bearing 34 provided at the front end of the gear case 31. The chuck 35 is coupled to the front end of the spindle 33, and the driving force from the motor 20 is transmitted to the tip tool attached on the chuck 35.

A screw 31A, configured of a male screw, is formed on an outer circumference of the front portion of the gear case 31, and a nut 51 of the clutch mechanism 50, described further below, is screwed onto the screw 31A. A clutch dial 36 is provided on radially outside of the front portion of the gear case 31. The clutch dial 36 is formed in a substantially cylindrical shape open to the rear and is rotatably coupled to the gear case 31 via the nut 51 described further below. An insertion hole 36A is formed through a front wall of the clutch dial 36, and the front end of the spindle 33 protrudes forward from the insertion hole 36A.

### Reduction Mechanism 40

As illustrated in FIG. 2, the reduction mechanism 40 is housed within the rear portion of the gear case 31. The reduction mechanism 40 is configured with a three-stage planetary gear mechanism. A first-stage of the planetary gear in the reduction mechanism 40 has a ring-shaped first ring gear 41, which is disposed radially outside the pinion gear 21A of the motor 20 and is coupled to the gear case 31 without relative rotation. Internal teeth are formed on an inner circumference of the first ring gear 41. Between the internal teeth and the pinion gear 21A, a plurality of first planetary gears 42 are provided, and the first planetary gears 42 are meshed with the pinion gear 21A and the first ring gear 41. A disc-shaped first carrier 43 is provided on the front of the pinion gear 21A, and the first planetary gear 42 is rotatably supported by the first carrier 43. In other words, the pinion gear 21A is configured as a sun gear. A sun gear 43A protruding forward is formed in a center of the first carrier 43.

A second-stage of the planetary gear mechanism in the reduction mechanism 40 has a ring-shaped second ring gear 44. The second ring gear 44 is disposed radially outward of the sun gear 43A and is coupled to the gear case 31 without relative rotation. The internal teeth are formed on the inner circumference of the second ring gear 44. Between the internal teeth and the sun gear 43A, a plurality of second planetary gears 45 are provided, and the second planetary gears 45 are meshed with the sun gear 43A and the second ring gear 44. A disc-shaped second carrier 46 is provided on the front of the sun gear 43A, and the second planetary gear 45 is rotatably supported by the second carrier 46. A sun gear 46A protruding forward is formed in the center of the second carrier 46.

A third-stage of the planetary gear mechanism in the reduction mechanism 40 has a ring-shaped third ring gear 47. The third ring gear 47 is disposed radially outward of the sun gear 46A and is rotatably supported by the gear case 31. A plurality of engagement protrusions 47A are formed on a front surface of the third ring gear 47. The engagement protrusions 47A are engaged with the clutch mechanism 50 described further below, and the third ring gear 47 is held non-rotatably by the clutch mechanism 50. The internal teeth are formed on the inner circumference of the third ring gear 47. Between the internal teeth and sun gear 46A, a third planetary gear 48 is provided, and the third planetary gear 48 is meshed with the sun gear 46A and the third ring gear 47. A disc-shaped third carrier 49 is provided on the front of the sun gear 46A, and the third planetary gear 48 is rotatably supported by the third carrier 49. A fitting hole 49A is formed through the center of the third carrier 49. The rear end of the spindle 33 is coupled to the fitting hole 49A without relative rotation and with a relative movement in the front-back direction. As described above, the rotational force of the motor 20 is transmitted by the reduction mechanism 40 to rotate the spindle 33.

### Clutch Mechanism 50

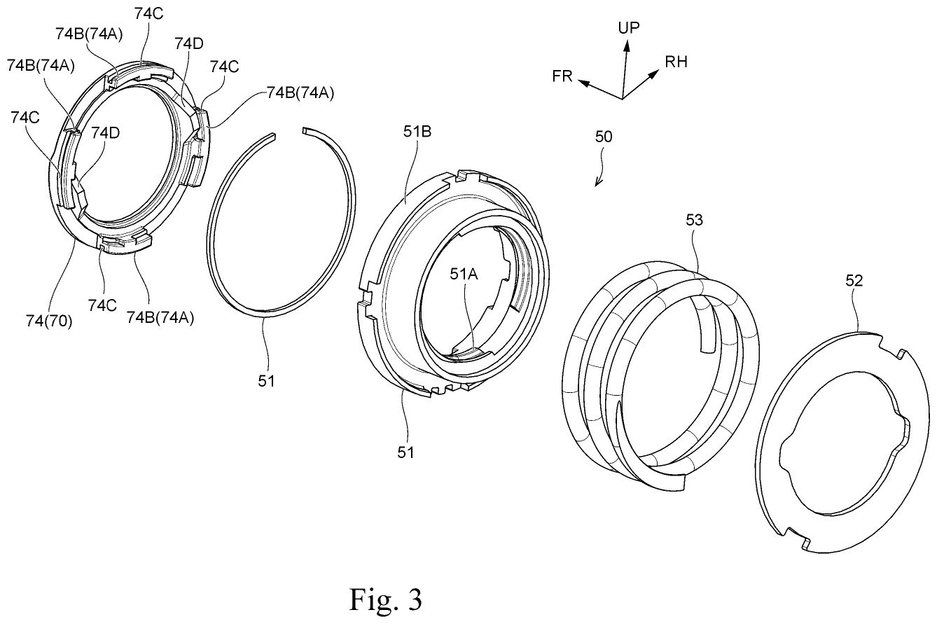

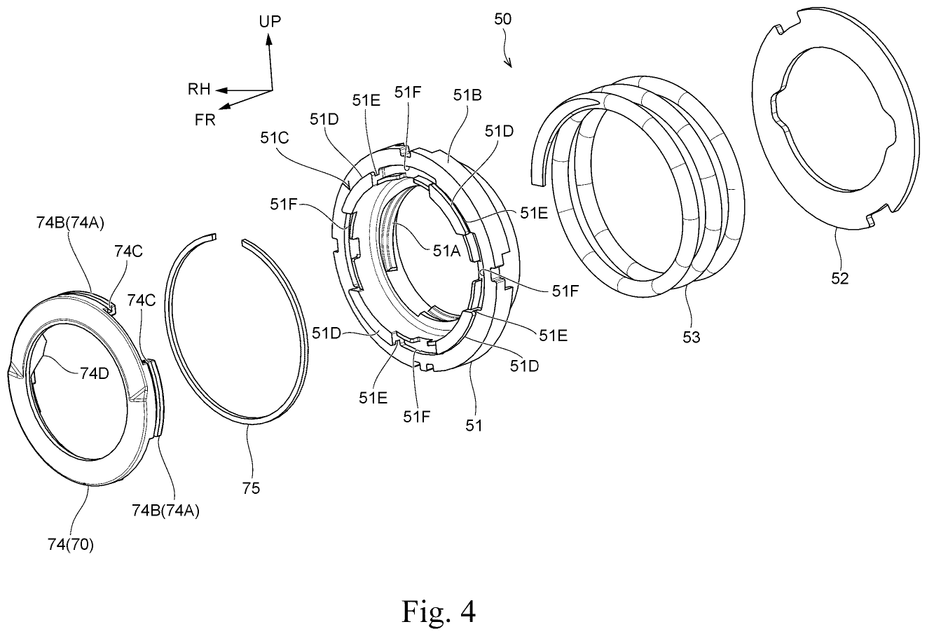

As illustrated in FIG. 2 through FIG. 4, the clutch mechanism 50 comprises: the nut 51 as a torque setting portion, a thrust plate 52, a clutch spring 53, and a plurality of balls 54. The nut 51 is formed in the substantially cylindrical shape with the front-back direction as the axial direction. The inner circumference of the nut 51 has a screw 51A, and a female screw is formed at the screw 51A. The nut 51 is inserted into the front portion of the gear case 31, and the screw 51A is screwed to the screw 31A of the gear case 31. A flange 51B protruding radially outward is formed on the front end of the nut 51. The flange 51B is disposed close to inner side of the clutch dial 36 in radial direction and is coupled to the clutch dial 36 in a manner that allows it to rotate integrally and in relative front-back direction. As a result, when the clutch dial 36 is rotated by an operator, the nut 51 rotates relative to the gear case 31 together with the clutch dial 36. Also, at this time, the nut 51 moves relative to the gear case 31 and the clutch dial 36 in the front-back direction due to a screw connection between the nut 51 and the gear case 31. Specifically, the nut 51 is configured to be movable between a detached position (a position illustrated on upper side of the spindle 33 in FIG. 2) and an approaching position (the position illustrated on lower side of the spindle 33 in FIG. 2), which is moved rearward from the detached position.

The front end of the nut 51 has a mounting portion 51C for mounting a switching ring 74 of the switching mechanism 70 described further below. The mounting portion 51C comprises a plurality (in this embodiment, four locations) of mounting convexes 51D and a plurality (in this embodiment, four locations) of mounting concaves 51F. The mounting convex 51D is formed in a form of a rib protruding forward from the inner circumference of the front end of the nut 51 and extending along circumferential direction of the nut, with the front end of the mounting convex 51D bending outward in the radial direction of the nut 51. In other words, the mounting convex 51D has a mooring groove 51E that is open to the outside of the nut 51 in the radial direction and extends in the circumferential direction of the nut 51. The four mounting convexes 51D are disposed spaced apart at equal intervals (every 90 degrees) in the circumferential direction of the nut 51.

The mounting concave 51F is formed on the inner circumference of the front end of the nut 51 and is disposed between adjacent mounting convexes 51D in the circumferential direction. In other words, the mounting convex 51D and the mounting concave 51F are arranged alternately in the circumferential direction of the nut 51. The mounting concave 51F extends in the circumferential direction of the nut 51 and is formed in a concave shape open to the front. An inner circumferential surface of the mounting concave 51F is disposed in the position one step lower in the radial direction inside of the nut 51 than a bottom surface of the mooring groove 51E.

The thrust plate 52 is formed in the shape of a substantially circular plate with the front-back direction as the thickness direction. The thrust plate 52 is inserted to the front portion of the gear case 31 and is positioned at the rear end of the front portion. The clutch spring 53 is configured as a compression coil spring. The clutch spring 53 is inserted into the nut 51, the front end of the clutch spring 53 is moored with the flange 51B, and the rear end of the clutch spring 53 is moored with the thrust plate 52. As a result, the clutch spring 53 forces the thrust plate 52 toward the rear.

A plurality of balls 54 (six balls in this embodiment) are inserted into the rear of the gear case 31 through ball holes 31B (see FIG. 6) formed in the gear case 31 and are disposed between the thrust plate 52 and the third ring gear 47. As a result, a force of the clutch spring 53 is transmitted to the ball 54 via the thrust plate 52, and the ball 54 presses the third ring gear 47 to the rear. When the reduction mechanism 40 is activated, the engagement protrusion 47A of the third ring gear 47 engages the ball 54, thereby holding the third ring gear 47 non-rotatable, and the driving force of the motor 20 is transmitted to the spindle 33. On the other hand, when the transmitted torque to the spindle 33 reaches the upper limit value during tightening or other works, the ball 54 pressed by the engagement protrusion 47A of the third ring gear 47 is displaced to the front with the thrust plate 52 against the force of the clutch spring 53, and the ball 54 climbs over the engagement protrusion 47A. As a result, the third ring gear 47 rotates and the drive transmission to the spindle 33 is interrupted.

By rotating the clutch dial 36 and moving the nut 51 from the detached position to the rear (toward the approaching position), the amount of compression deformation of the clutch spring 53 increases, and the force of the clutch spring 53 increases. Therefore, by rotating the clutch dial 36, the upper limit value of the torque transmitted to the spindle 33 during tightening or other works can be changed. In the approaching position of the nut 51, the rear end of the nut 51 contacts the thrust plate 52 from the front. This restricts a movement of the thrust plate 52 to the front, and the clutch mechanism 50 is set to be inoperative.

### Striking-Force-Application Mechanism 60

As illustrated in FIG. 2, FIG. 5, and FIG. 6, the striking-force-application mechanism 60 comprises: a first ratchet 61, a second ratchet 62, and a force spring 63 (which, broadly speaking, is an element understood as a force member). The striking-force-application mechanism 60 is disposed radially outwardly of the middle in the axial direction of the spindle 33 and is housed within the front portion of the gear case 31. The first ratchet 61 is formed in the substantially cylindrical shape with the front-back direction as the axial direction, and the middle in the axial direction of the spindle 33 is fitted into the first ratchet 61 to fix the first ratchet 61 to the spindle 33 for integral rotation. A plurality of ratchet teeth are formed on a rear surface of the first ratchet 61, and the plurality of ratchet teeth are arranged in line in the circumferential direction of the first ratchet 61. The first ratchet 61 is disposed adjacent to the rear of the bearing 34.

The second ratchet 62, like the first ratchet 61, is formed in the substantially cylindrical shape with the front-back direction as the axial direction. The second ratchet 62 is supported by the spindle 33 at the rear of the first ratchet 61 for relative rotation. A plurality of ratchet teeth are formed on the front surface of the second ratchet 62, and the plurality of ratchet teeth are configured to engage with the ratchet teeth of the first ratchet 61. During tightening or other operations, the spindle 33 moves rearward to engage the ratchet teeth of the first ratchet 61 and second ratchet 62 by pressing the tip tool against a material to be processed. A plurality of ratchet pawls 62A are formed on the outer circumference of the second ratchet 62, and the ratchet pawls 62A are arranged at equal intervals in the circumferential direction of the second ratchet 62.

The force spring 63 is configured as the compression coil spring and is inserted into the spindle 33. The force spring 63 is housed in a concave formed in the inner circumference of the first ratchet 61 and the second ratchet 62, and forces both of them outward in the front-back direction. As will be described in detail further below, in the inoperative state of the striking-force-application mechanism 60, the second ratchet 62, which is engaged with the first ratchet 61, rotates integrally with the first ratchet 61 so that no striking force is applied to the spindle 33. On the other hand, in the operative state of the striking-force-application mechanism 60, the rotation of the second ratchet 62 is set to be prevented by the switching mechanism 70 described below. Therefore, the ratchet teeth of the first ratchet 61 climb over the ratchet teeth of the second ratchet 62 against the force of the force spring 63, so that the striking force is applied to the spindle 33 in the front-back direction.

### Switching Mechanism 70

As illustrated in FIG. 2 through FIG. 6, the switching mechanism 70 comprises: a pair of slip blocks 71 (which, broadly speaking, are elements to be understood as locking members); a pair of stopper springs 73; and a switching ring 74 as a switching member. The pair of slip blocks 71 are disposed radially outwardly of the striking-force-application mechanism 60 and are housed in the front portion of the gear case 31 slidable in front-back direction, and are disposed spaced 180 degrees apart in the circumferential direction of the gear case 31. Specifically, the slip block 71 is configured to be slidable between a non-locked position (position illustrated above the spindle 33 in FIG. 2) and a locked position (position illustrated below the spindle 33 in FIG. 2). In the non-locked position, the front portion of the slip block 71 is disposed radially outside of the first ratchet 61, and in the locked position, the front portion of the slip block 71 is positioned radially outside of the second ratchet 62.

A plurality of lock pawls 71A, corresponding to the ratchet pawl 62A of the second ratchet 62, are formed on the front portion of the slip block 71. The lock pawls 71A are disposed at equal intervals in the circumferential direction of the slip block 71. In the locked position of the slip block 71, the lock pawl 71A is inserted between circumferentially adjacent ratchet pawls 62A in the second ratchet 62, and the lock pawl 71A and ratchet pawl 62A are circumferentially engaged to prevent the second ratchet 62 from rotating. In other words, the striking-force-application mechanism 60 is switched from the inoperative state to the operative state.

The slip block 71 is provided with a pin 72 with the radial direction of spindle 33 as the axial direction. The pin 72 protrudes from the slip block 71 outward in the radial direction of the spindle 33 and is inserted in a slit 31C formed in the gear case 31 slidable in the front-back direction. The tip of the pin 72 protrudes radially outward from the gear case 31 and is disposed in front of the screw 51A of the nut 51.

The stopper spring 73 is configured as the compression coil spring. The stopper spring 73 is housed in the front portion of the gear case 31 and is disposed behind the slip block 71 and forces the slip block 71 toward the front. As a result, the slip block 71 is held in the non-locked position by the force of the stopper spring 73.

The switching ring 74 is formed in the substantially cylindrical shape with a relatively short shaft length with the front-back direction as the axial direction. The switching ring 74 is removably mounted to the mounting portion 51C of the nut 51 and is disposed on the front of the nut 51. The rear end of the switching ring 74 is provided with a mounted portion 74A that is mounted to the mounting portion 51C. The mounted portion 74A has four mounted convexes 74B corresponding to the mounting concaves 51F of the nut 51. The mounted convex 74B is formed in the shape of the rib extending in the circumferential direction of the switching ring 74, and the front end of the mounted convex 74B is bent outward in the radial direction of the switching ring 74. In other words, the mounted convex 74B has a mooring groove 74C open to outside of the switching ring 74 in the radial direction and extending in the circumferential direction of the switching ring 74. The mounted convex 74B is fitted into the mounting concave 51F of the nut 51 from the front, and the switching ring 74 is mounted in a state of being engaged with the nut 51 in the circumferential direction. In a mounted state of the switching ring 74 to the nut 51, the mooring groove 51E of the nut 51 and the mooring groove 74C of the switching ring 74 are communicating in the circumferential direction. A C-ring 75 as a mooring member is fitted into the mooring groove 51E and the mooring groove 74C, and the C-ring 75 moors the switching ring 74 to the nut 51 to maintain the mounted state of the switching ring 74.

The switching ring 74 is provided with a pair of pressure pieces 74D. The pressure piece 74D is disposed radially inward than the mounted convex 74B and protrude rearward from the switching ring 74. The pressure piece 74D is formed in a substantially rectangular plate with the radial direction of the switching ring 74 as the thickness direction and the circumferential direction of the switching ring 74 as longitudinal direction. The pair of pressure pieces 74D are disposed 180 degrees apart in the circumferential direction of the switching ring 74 and are disposed in the position corresponding to the pin 72 of the slip block 71. In the detached position of the nut 51, the pressure piece 74D is disposed in the position at a forward separation to the pin 72 of the slip block 71 in the non-locked position. On the other hand, in the approaching position of the nut 51, the pressure piece 74D presses the pin 72 of the slip block 71 to the rear, so that the slip block 71 is disposed in the locked position.

### Effects

Next, operation and effects of the present embodiment will be described.

When using the driver drill 1 configured as described above to perform fastening or other works, a driver bit as the tip tool is mounted to the chuck 35 and put the driver drill 1 in the rotation mode. In the rotation mode of the driver drill 1, the nut 51 is disposed in the front with respect to the approaching position. When the motor 20 is driven by the operator's pull operation to the trigger 12, the driving force of the motor 20 is transmitted to the spindle 33 by the reduction mechanism 40, and the tip tool rotates with the spindle 33. When the transmission torque to the spindle 33 reaches the upper limit value, the clutch mechanism 50 is activated to shut off the drive transmission to the spindle 33. Specifically, the third ring gear 47 of the reduction mechanism 40 rotates relative to the ball 54 against the force of the clutch spring 53. As a result, the drive transmission to spindle 33 is cut off. Furthermore, by rotating the clutch dial 36 and moving the nut 51 to the rear, the amount of compression deformation of the clutch spring 53 is increased. This allows the operator to change the upper limit value of the transmission torque to the spindle 33.

In the rotating mode of the driver drill 1, the slip block 71 of the switching mechanism 70 does not reach the locked position and the striking-force-application mechanism 60 remains inoperative. In other words, when the tip tool is pressed against the material to be processed during tightening operation, the spindle 33 moves rearward and the ratchet teeth of the first ratchet 61 of the striking-force-application mechanism 60 engage the ratchet teeth of the second ratchet 62, but the relative rotation of the second ratchet 62 is permitted. Therefore, the second ratchet 62, together with the first ratchet 61, rotates together with the spindle 33 to maintain the inoperative state of the striking-force-application mechanism 60.

On the other hand, when, for example, a drill as the tip tool is mounted to the chuck 35 to perform drilling or other works, the driver drill 1 is set to the rotary striking mode. In the rotary striking mode of the driver drill 1, the nut 51 is moved to the approaching position by the operator's rotary operation of the clutch dial 36. As a result, the rear end of the nut 51 contacts the thrust plate 52 from the front and restricts the thrust plate 52 from moving forward. As a result, the clutch mechanism 50 becomes inoperative. In the approaching position of the nut 51, the pin 72 of the slip block 71 is pressed by the pressure piece 74D of the switching ring 74 to dispose the slip block 71 in the locked position. This disposes the lock pawl 71A of the slip block 71 and the ratchet pawl 62A of the second ratchet 62 of the striking-force-application mechanism 60 in the position of circumferential engagement of the second ratchet 62, that is, the rotation of the second ratchet 62 is prevented and the striking-force-application mechanism 60 is in the operative state.

When the tip tool is pressed against the material to be processed during operation, the spindle 33 moves rearward and the ratchet teeth of the first ratchet 61 and the second ratchet 62 engage each other. When spindle 33 rotates by the driving force of the motor 20, the ratchet teeth of the first ratchet 61 climb over the ratchet teeth of the second ratchet 62 against the force of the force spring 63, since the rotation of the second ratchet 62 is prevented by the slip block 71. As a result, the striking force is applied to the spindle 33 and the tip tool when the spindle 33 rotates.

Here, in the driver drill 1, the switching ring 74 of the switching mechanism 70, which switches the striking-force-application mechanism 60 of the driver drill 1 to the inoperative or operative state, is removably mounted to the nut 51 of the clutch mechanism 50. In other words, the nut 51 has the mounting portion 51C for mounting the switching ring 74 that switches an operation mode of the spindle 33. This allows the driver drill 1 to accommodate variations while contributing to the downsizing of a body size.

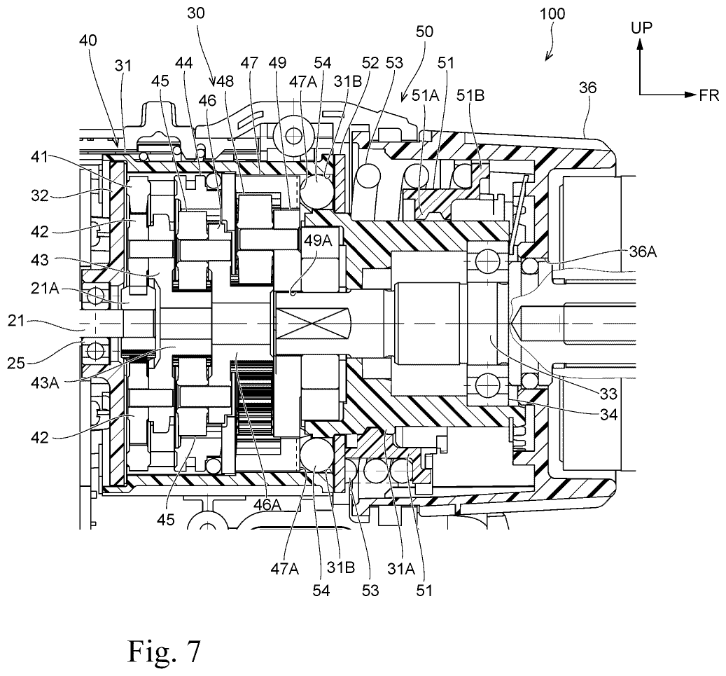

In other words, when making a driver drill 100 having only the rotation mode, as illustrated in FIG. 7, the driver drill 100 is configured to omit the striking-force-application mechanism 60 and the switching mechanism 70 for the driver drill 1. In other words, the driver drill 100 can be configured by removing the switching ring 74 of the switching mechanism 70 from the nut 51 and eliminating the striking-force-application mechanism 60 and the switching mechanism 70 from the driver drill 1. This allows the body size of the driver drill 100 in the front-back direction to be downsized, rather than if the nut 51 and the switching ring 74 were made as an integrated part of the driver drill 1 and the driver drill 100. Therefore, it is possible to accommodate variations of the driver drill 1 while contributing to the downsizing of the body size. In the driver drill 100, a smaller driver drill 100 can be produced in relation to the driver drill 1 by producing the gear case 31 and so on that corresponds to the dimensions of the nut 51 in the front-back direction.

The nut 51 is disposed on the front of the reduction mechanism 40 and is configured to be movable in the front-back direction. Furthermore, the mounting portion 51C of the nut 51 is provided at the front end of the nut 51, and the slip block 71 of the switching mechanism 70 is disposed inside in the radial direction of the nut 51. This allows the body size of the driver drill 1 in the front-back direction to be further downsized. In other words, if the mounting portion 51C were to be provided at the rear end of the nut 51, the switching ring 74 would be disposed rearward than the screw 51A of the nut 51. Therefore, the slip block 71 and the striking-force-application mechanism 60, which are operated by the switching ring 74, are disposed rearward compared to the present embodiment. Therefore, in this case, the gear case 31 and the spindle 33 need to be extended forward compared to the present embodiment. In other words, the body size of the driver drill 1 tends to become larger in the front-back direction. In contrast, in the present embodiment, the mounting portion 51C is provided at the front end of the nut 51. Therefore, the switching ring 74 can be disposed in front than the screw 51A of the nut 51, and the slip block 71 and the striking-force-application mechanism 60, which are operated by the switching ring 74, can be disposed inside in the radial direction of the screw 51A of the nut 51. Thus, the body size of the driver drill 1 in the front-back direction can be further downsized.

The mounted convex 74B of the switching ring 74 is fitted into the mounting concave 51F of the nut 51, and the mounted portion 74A and the mounting portion 51C are circumferentially engaged with the nut 51. Then, the C-ring 75 is mounted to the mooring groove 51E of the nut 51 and the mooring groove 74C of the switching ring 74, and the C-ring 75 restricts a front-back direction movement of the switching ring 74 with respect to the nut 51. In other words, the C-ring 75 maintains the mounted state of the switching ring 74. This allows the switching ring 74 to be mounted to the nut 51 with a simple configuration and improves mounting of the switching ring 74 to the nut 51.

### DESCRIPTION OF REFERENCE NUMERALS

1: Driver drill (work machine)
20: Motor
33: Spindle
40: Reduction mechanism (transmission mechanism)
50: Clutch mechanism
51: Nut (torque setting portion)
51C: Mounting portion
60: Striking-force-application mechanism
70: Switching mechanism
74: Switching ring (switching member)
74A: Mounted portion
75: C ring (mooring member)

1. A work machine comprising:
a motor;
a transmission mechanism that transmits a driving force of the motor to a spindle to rotate the spindle;
a clutch mechanism that shuts off power transmission from the motor to the spindle when a transmission torque to the spindle by the transmission mechanism reaches an upper limit value; and
a torque setting portion that configures a portion of the clutch mechanism and is activated by an operator to set the upper limit value;
wherein the torque setting portion has a mounting portion for mounting a switching member that switches an operation mode of the spindle.

2. A work machine comprising:
a motor;
a transmission mechanism that transmits a driving force of the motor to a spindle to rotate the spindle;
a clutch mechanism that shuts off power transmission from the motor to the spindle when a transmission torque to the spindle by the transmission mechanism reaches an upper limit value;
a torque setting portion that configures a portion of the clutch mechanism and is activated by an operator to set the upper limit value; and
a switching member provided in front of the torque setting portion in axial direction of the spindle and operated by the operator to switch an operation mode of the spindle.

3. The work machine according to claim 1, comprising:
a striking-force-application mechanism provided on radially outside of the spindle to apply a striking force in axial direction of the spindle; and
a switching mechanism that switches the striking-force-application mechanism to an operative or inoperative state;
wherein the switching member configures the portion of the switching mechanism.

4. The work machine according to claim 3,
wherein the torque setting portion is disposed on one side in the axial direction with respect to the transmission mechanism and is movable in the axial direction,
wherein the mounting portion is provided at one end of the torque setting portion in the axial direction, and the switching mechanism is disposed radially inside of the spindle with respect to the torque setting portion.

5. The work machine according to claim 4,
wherein the torque setting portion and the switching member are formed in a cylindrical shape disposed radially outside of the spindle,
wherein the switching member has a mounted portion that is mounted to the mounting portion,
wherein the mounted portion is mounted to the mounting portion in a circumferential engagement with the torque setting portion and is moored to the mounting portion by a mooring member.

6. The work machine according to claim 5,
wherein the mooring member is a C-ring mounted to the mounting portion and the mounted portion.
